(19) United States
(12) Patent Application Publication
(10) Pub. No.: US 2010/0126328 A1
(43) Pub. Date: May 27, 2010

(54) JIGSAW BLADE FOR HAND-HELD POWER JIGSAWS

(76) Inventor: Daniel GROLIMUND, Zuchwill (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/621,131

(22) Filed: Nov. 18, 2009

(30) Foreign Application Priority Data
Nov. 27, 2008 (DE) 10 2008 044108.2

(51) Int. Cl. B23D 61/12

(52) U.S. Cl. 83/848; 83/855

(57) ABSTRACT

A jigsaw blade having a clamping end and, adjoining it, a blade-like working body that has a row of saw teeth that is inclined in relation to the clamping end, a spine on the opposite side from the row of teeth, and a tip at the front is therefore safer, easier to use, has higher performance, and is more precise. The jigsaw blade has two tooth row regions of the row of saw teeth that are inclined at different angles in relation to the clamping end.

### CROSS-REFERENCE TO RELATED APPLICATION

This application is based on German Patent Application 10 2008 044 108.2 filed Nov. 27, 2008.

### BACKGROUND OF THE INVENTION

1. Field of the Invention

The invention relates to a jigsaw blade, in particular for hand-held power jigsaws.

2. Description of the Prior Art

There are known jigsaw blades whose rows of teeth are offset at an angle in relation to the clamping end in the advancing direction. Because of this inclination, the row of teeth has a progressively extending engagement in a work piece to be sawn during the course of the upward- and rearward-oriented working stroke. As a result, each tooth of the row of teeth contacting the work piece penetrates with ever greater cutting depth into the work piece during its working stroke. This yields the desired, aggressive cutting behavior when these saw blades are used in jigsaws. During the downward- and forward-oriented return- or idle stroke, the inclination of the row of teeth causes the saw blade to lift immediately away from the work piece, thereby relieving the stress on the blade. As a result, it heats up less, is cooled better, and has a longer service life than conventional saw blades. Particularly when sawing without an orbital action, a significantly better material removal is achieved than with conventional saw blades. If the inclination of the row of teeth is greater than 5′, these saw blades begin to vibrate and jolt with ever greater intensity despite favorable performance parameters. This has a negative influence on ease-of-use, safety, work quality of the sawing, and service life of the saw blade. The longer these saw blades are, the more powerful the vibrations and jolts are, due to the greater bending moment and deformation at the end of the saw blade during sawing. In long saw blades, this can cause damage, particularly at the clamping end, and can therefore lead to premature failure of the saw blade.

### ADVANTAGES AND SUMMARY OF THE INVENTION

The invention, has the advantage over the prior art that greater inclinations of the row of teeth than were previously possible yield a further improvement of the cutting performance and cutting quality in jigsaws, while avoiding the prior disadvantages.

Because only the first tooth row subregion adjacent to the clamping end or clamping shaft is inclined in relation to the clamping end and not the entire row of teeth—as in the known saw blades, its inclination angle can be greater than the previously customary 5°, without the occurrence of the prior disadvantages. In this case, increased bending moments and deformations occur only at the beginning of the sawing stroke, namely in the first subregion of the inclination. They have far less of a negative impact there than in the region close to the saw blade tip. Since the additional tooth row subregion is inclined significantly less than the first subregion, i.e. can extend approximately parallel to the clamping end, the bending moments and deformations occurring there are significantly less intense than in the first subregion so that particularly in this additional subregion, the described disadvantages of the prior art do not arise.

The invention has the advantage that the work piece region being sawn by the first tooth row subregion with the more intense inclination, usually situated closer to the base plate of jigsaw, can be cut with faster saw progress than the remaining work piece region.

Particularly when sawing thinner materials and smaller pipe diameters, with the saw blade according to the invention, the cutting performance is noticeably higher, the bending stress on the saw blade shaft is increased only slightly in comparison to conventional saw blades, and the ease of sawing is not impaired but rather improved. In particular, there is an improvement in the starting, or more specifically, the start of sawing.

With greater material thicknesses and pipe diameters, however, both tooth row regions are in use so that the better sawing progress is achieved only in the first phase of the sawing, during use of the inclined tooth row region while in the second phase, when the parallel tooth row region is being used for sawing, ease of use is improved more than the sawing progress. The two different angles of approach of the tooth row limit the cutting and bending forces at the saw blade tip in longer saw blades.

With a selective dimensioning of the length of the inclined region of the saw blade, its action can be matched to various material thicknesses and material types of the work piece.

In long saw blades, if sawing is carried out only with the region close to the saw blade tip, then the less intensely inclined additional subregion is not in use and has no influence on the sawing.

Because the first tooth row region of the row of saw teeth immediately adjacent to the clamping end is inclined in relation to the clamping end and an additional tooth row region of the row of saw teeth, in particular adjacent to the first region, is inclined less in relation to the clamping end than the first tooth row region, or extends parallel to or even at a negative inclination in relation to the clamping end, in the cutting channel close to the saw blade tip, the cutting quality is finer and the cut edge of the work piece has fewer tear-outs.

The fact that the first tooth row region measures approximately 1/3 the length of the row of saw teeth achieves a high cutting performance combined with a high cutting quality.

The fact that the row of saw teeth is approximately 70 to 150 mm long, with an angle of the inclined tooth row region in relation to the clamping end of 2° to 6°, permits favorable control of the bending forces acting on the clamping end.

The advantage of the novel saw blade can be achieved in jigsaws if the clamping end belongs to a jigsaw blade.

The advantage of the novel saw blade can be achieved in sabre saws if the clamping end belongs to a sabre saw blade.

When the transition between the two tooth row regions is embodied in the form of a curved contour, the change between the tooth row regions causes no negative repercussions for the user during sawing and can be controlled with particular ease.

### BRIEF DESCRIPTION OF THE DRAWINGS

The invention will be better understood and further objects and advantages thereof will become more apparent from the ensuing detailed description of preferred embodiments taken in conjunction with the drawings, in which.

FIG. 1 shows the saw blade according to the invention for a sabre saw;

FIG. 2 shows the saw blade according to the invention for a jigsaw; and

FIG. 3 shows a jigsaw equipped with the saw blade according to FIG. 2.

### DESCRIPTION OF THE PREFERRED EMBODIMENTS

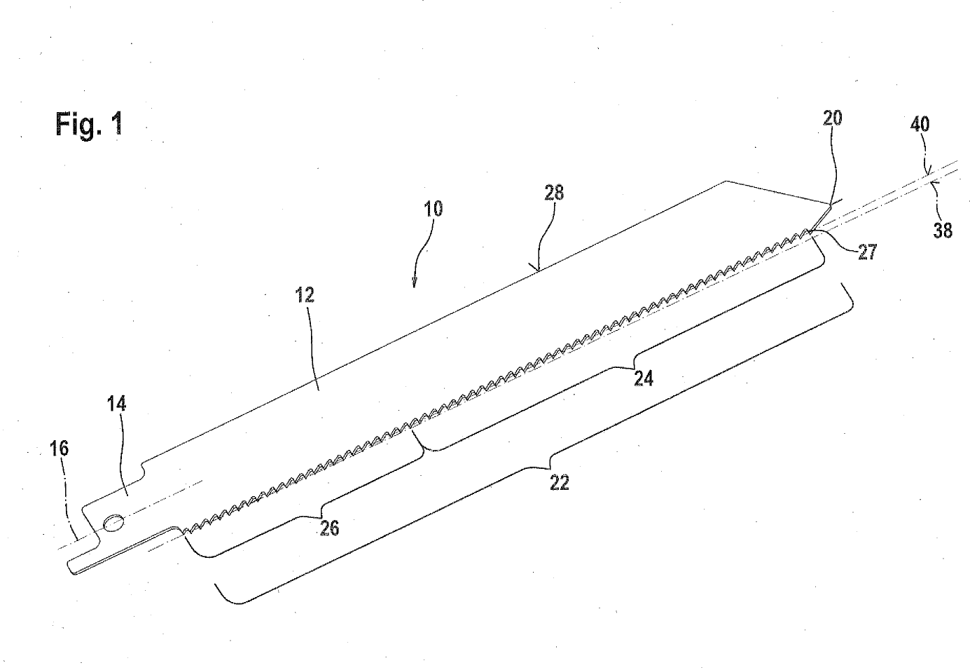

The sabre saw blade 10 according to the invention shown in FIG. 1 is composed of a long, flat, blade-like working body 12 that has the clamping end 14 at the rear and a saw blade tip 20 at the front. The clamping end 14 has a central axis 16 and is narrower than the working body 12 and is therefore relatively sensitive to powerful bending moments in the plane of the saw blade 10. At the saw blade tip 20, the lower flat side is adjoined by a row of saw teeth 22 extending toward the rear. A saw blade spine 28 extends on the rear side or flat side of the working body 12.

A first tooth row region 26 of the row of saw teeth 22 immediately adjacent to the clamping end 14 is inclined positively in relation to the axis 16 of the clamping end 14, at an angle of approximately 5°—downward in the viewing direction of the drawing. The inclined first tooth row region 26 measures approximately ⅓ the length of the row of saw teeth 22 and transitions into a second tooth row region 24 extending parallel to the axis 16, all the way to the first saw tooth 27 at the saw blade tip 20. The clamping end 14 can also be considered to extend at an angle in relation to the saw blade axis.

A transition region between the first and second tooth row regions 24, 26 can form a sharp intersection point of the geometric lines touching the tips of the teeth or can extend in the form of a curve.

The angle between the axes 38, 40 of the tooth row regions 24, 26 at the tips of their teeth is clearly visible; the angle of the axis 38 of the first tooth row region 26 to the axis 16 of the clamping end 14 is significantly greater than the angle of the axis 40 of the second tooth row region 24. The axis 40 of the second tooth row region 24 extends virtually parallel to the axis 16 of the clamping end 14.

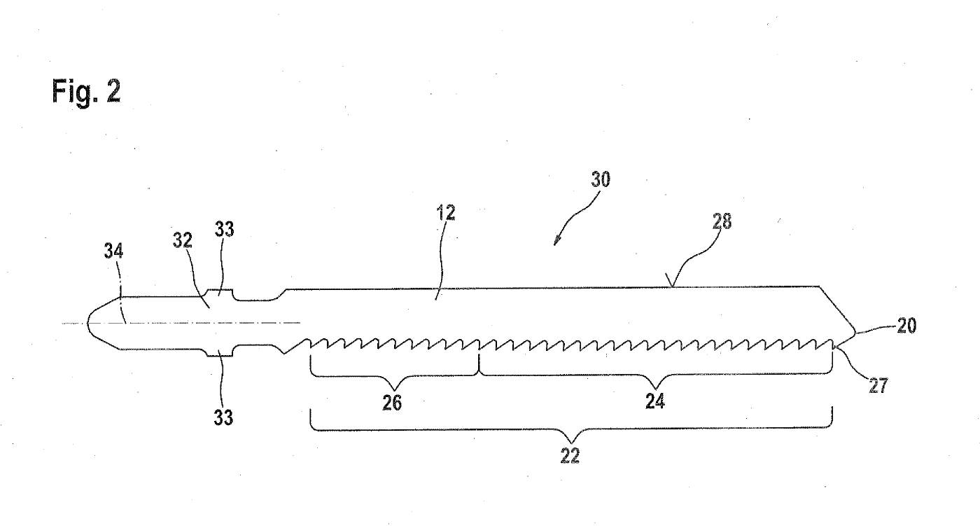

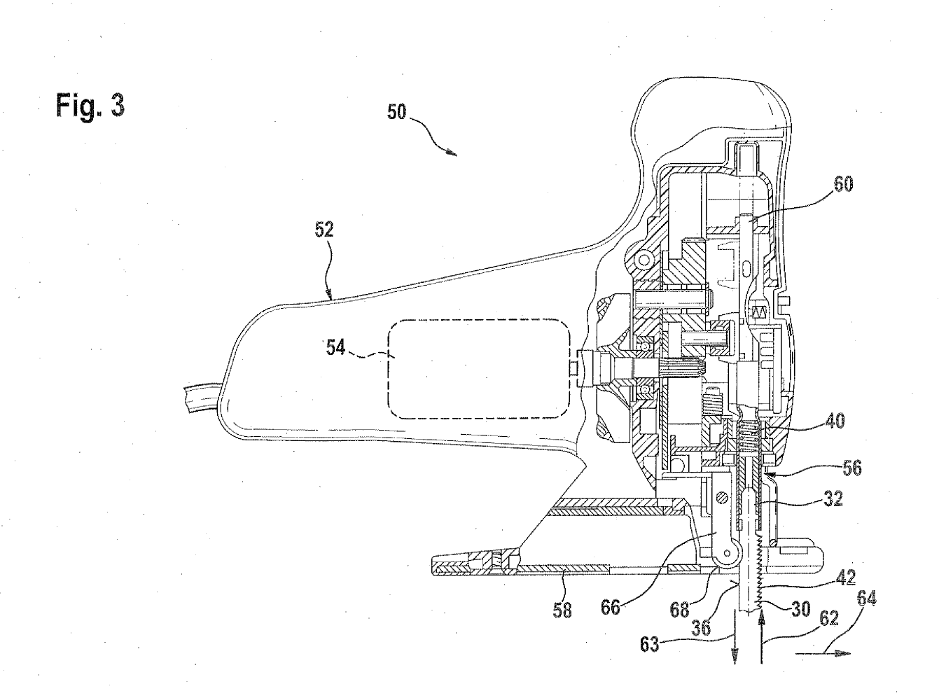

The saw blade 30 according to the invention shown in FIG. 2, which is intended for a jigsaw 50 (FIG. 3), is composed of a long, flat, blade-like working body 12, the rear end of which has a clamping end 32 equipped with cams 33 and the front end of which has a saw blade tip 20. The clamping end 32 is not as wide as the working body 12 and is therefore relatively sensitive to powerful bending moments in the plane of the saw blade 30. At the saw blade tip 20, the lower flat side is adjoined by a rearward-extending row of teeth 22. A saw blade spine 28 extends on the rear side or upper flat side of the saw blade. A first tooth row region 26 of the row of teeth 22 immediately adjacent to the clamping end 32 is inclined at a positive angle of approximately 5⁰ in relation to the axis 16 of the clamping end 32. This inclined first tooth row region 26 measures approximately ⅓ the length of the row of teeth 22 and transitions into a second tooth row region 24 that extends parallel to the axis 16, all the way to the first saw tooth 27 at the saw blade tip 20.

The jigsaw 50 shown in FIG. 3 is composed of a housing 52 that contains a symbolically depicted motor 54. The motor 54 serves to drive a lifting rod 60 and, via a transmission that is not shown in detail, imparts a reciprocating motion to it, which is transmitted to the saw blade 30. The clamping end 32 of the saw blade 30 permits it to be detachably clamped into a saw blade clamping device 56 at the end of the lifting rod 60. On its underside, the housing 52 is attached in pivoting fashion to a base plate 58 that the saw blade 30 protrudes down through in order, underneath the base plate 58, to come into a material-removing tool engagement and to saw forward in the advancing direction indicated by the directional arrow 64 during the upward- or working stroke of the saw blade 30 indicated by the directional arrow 62.

The lifting rod 30 is supported so that it is able to move in a straight line in the housing 52 by means of upper and lower lifting rod bearings, not shown in detail, and at its lower end, supports the saw blade clamping device 56 for accommodating the clamping end 32 of the saw blade 30.

With the downward stroke of the lifting rod 60 and saw blade 30 indicated by the directional arrow 63 following each working stroke, the inclination causes the row of teeth 42 to immediately disengage from a work piece to be sawn. The saw blade 30 is supported with its saw blade spine 36 in a pendulum roller 68 of a pendulum arm 66, which can cause the saw blade 30 to execute a back-and-forth orbital action oriented in the advancing direction shown by arrow 64.

The foregoing relates to preferred exemplary embodiments of the invention, it being understood that other variants and embodiments thereof are possible within the spirit and scope of the invention, the latter being defined by the appended claims.

I claim:

1. A jigsaw blade (10, 30) comprising:
a clamping end (14, 32) and, adjoining it;
a blade-like working body (12) that has a row of saw teeth (22) that is inclined in relation to the clamping end (14, 32), a spine (28) on the opposite side from the row of teeth, and a free end, in particular a tip (20, at a front end of the working body opposite the clamping end, the row of saw teeth having two tooth row regions (24, 26) that are inclined at different angles in relation to the clamping end.

2. The jigsaw blade as recited in claim 1, wherein the first tooth row region of the row of saw teeth is immediately adjacent to the clamping end and is inclined in relation to the clamping end, and an additional tooth row region of the row of saw teeth adjoining the first region, is inclined at less of an angle in relation to the clamping end than the first tooth row region.

3. The jigsaw blade as recited in claim 1, wherein the additional tooth row region extends essentially parallel to the clamping end and its axis.

4. The jigsaw blade as recited in claim 2, wherein the additional tooth row region extends essentially parallel to the clamping end and its axis.

5. The jigsaw blade as recited in claim 1, wherein the first saw tooth row region measures approximately ⅓ the length of the row of saw teeth.

6. The jigsaw blade as recited in claim 2, wherein the first saw tooth row region measures approximately ⅓ the length of the row of saw teeth.

7. The jigsaw blade as recited in claim 3, wherein the first saw tooth row region measures approximately ⅓ the length of the row of saw teeth.

8. The jigsaw blade as recited in claim 4, wherein the first saw tooth row region measures approximately ⅓ the length of the row of saw teeth.

9. The jigsaw blade as recited in claim 1, wherein the row of saw teeth is approximately 70 to 150 mm long.

10. The jigsaw blade as recited in claim 5, wherein the row of saw teeth is approximately 70 to 150 mm long.

11. The jigsaw blade as recited in claim 1, wherein the angle of the inclined tooth row region in relation to the clamping end is 2° to 6°.

12. The jigsaw blade as recited in claim 2, wherein the angle of the inclined tooth row region in relation to the clamping end is 2° to 6°.

13. The jigsaw blade as recited in claim 3, wherein the angle of the inclined tooth row region in relation to the clamping end is 2° to 6°.

14. The jigsaw blade as recited in claim 10, wherein the angle of the inclined tooth row region in relation to the clamping end is 2° to 6°.

15. The jigsaw blade as recited in claim 1, wherein the angle of the inclined tooth row region in relation to a longitudinal axis of the clamping end is 2° to 6°.

16. The jigsaw blade as recited in claim 1, wherein the clamping end belongs to a jigsaw blade.

17. The jigsaw blade as recited in claim 8, wherein the clamping end belongs to a jigsaw blade.

18. The jigsaw blade as recited in claim 1, wherein the clamping end belongs to a sabre saw blade.

19. The jigsaw blade as recited in claim 8, wherein the clamping end belongs to a sabre saw blade.

20. The jigsaw blade as recited in claim 1, wherein the transition between the two tooth row regions forms a curved contour.
